(19) United States
(12) Patent Application Publication
(10) Pub. No.: US 2025/0254157 A1
(43) Pub. Date: Aug. 7, 2025

(54) Application Programming Interface Access in a Communication Network

(71) Applicant: Telefonaktiebolaget LM Ericsson (publ), Stockholm (SE)

(72) Inventors: Ferhat Karakoc, Istanbul (TR); Wenliang Xu, Shanghai (CN)

(21) Appl. No.: 18/854,426

(22) PCT Filed: May 5, 2023
(86) PCT No.: PCT/EP2023/061885

§ 371 Date: Oct. 4, 2024

(30) Foreign Application Priority Data
May 6, 2022 (WO) PCT/CN2022/091149

(51) Int. Cl. H04L 9/40; G06F 9/54

(52) U.S. Cl. CPC H04L 63/083; G06F 9/547

(57) ABSTRACT

Communication equipment (16) is configured to invoke an application programming interface (API) (14) to access a service. The communication equipment (16) transmits, from the communication equipment (16) to API exposing equipment (12) configured to expose the API (14), a request (18) to invoke the API (14). The communication equipment (16) also transmits, from the communication equipment (16) to the API exposing equipment (12), an access token (20) that indicates whether a resource owner (24) consents (26) to the communication equipment (16) accessing a protected resource (22) of the API (14). The API exposing equipment (12) may verify the request (18) based on the access token (20), e.g., by verifying the request (18) against one or more claims in the access token (20). The API exposing equipment (12) may then accept or reject the request (18) depending on that verification.

### TECHNICAL FIELD

The present disclosure relates generally to a communication network, and relates more particularly to access to an application programming interface in such a network.

### BACKGROUND

The next generation (5G) core network (CN) uses a service-based architecture that leverages service-based interactions between CN network functions (NFs). An NF in this regard enables other authorized NFs to access a service provided by the NF via a service application programming interface (API). This service API is thereby the interface through which a component of the communication network (e.g., an NF) exposes its services, e.g., by abstracting the service from the underlying mechanisms. When the service API is exposed to higher-layer entities for invocation, the service API is referred to as a northbound API.

With multiple APIs existing, e.g., for different services, a so-called common API framework (CAPIF) includes common aspects applicable to any of multiple APIs. The CAPIF avoids duplication and inconsistencies between different APIs.

However, challenges exist in invoking an API, e.g., via the CAPIF, when some resources of the API are protected. For example, some objects or components of the API, such as a user's location, may be protected against unauthorized access, e.g., to protect the privacy of a user. In these and other cases, access to a protected resource of the API may be allowed only upon consent of the resource's owner. Resource owner consent as a prerequisite to resource access complicates API invocation, making it challenging to invoke an API for access to a protected resource in a way that is efficient from a signaling and processing perspective.

### SUMMARY

Some embodiments herein exploit an access token for indicating whether a resource owner consents to communication equipment accessing a protected resource of an application programming interface (API), e.g., in addition to the access token indicating whether the communication equipment is authorized to access the API. The communication equipment in this case may provide the access token along with its request to access the API. Other embodiments herein incorporate retrieval of user consent parameters into the API invocation procedure. Either way, steps for authorizing access to the API by the communication equipment can be efficiently avoided or aborted if the access token or the user consent parameters indicate the resource owner has not consented to the communication equipment accessing the protected resource. By exploiting the access token or the user consent parameters in this way, then, some embodiments herein provide a way to invoke the API for access to the protected resource in a way that is efficient from a signaling and processing perspective.

More particularly, embodiments herein include a method performed by communication equipment configured to invoke an application programming interface, API, to access a service. The method comprises transmitting, from the communication equipment to API exposing equipment configured to expose the API, a request to invoke the API. The method also comprises transmitting, from the communication equipment to the API exposing equipment, an access token that indicates whether a resource owner consents to the communication equipment accessing a protected resource of the API.

In some embodiments, the access token is included in the request.

In some embodiments, transmitting the request and the access token comprises transmitting, to the API exposing equipment, a message that includes both the request and the access token.

In some embodiments, transmitting the access token comprises transmitting the access token to the API exposing equipment before, or at the same time as, transmitting the request to the API exposing equipment.

In some embodiments, the access token includes consent information asserting that the resource owner consents, or does not consent, to the communication equipment accessing the protected resource of the API. In one or more of these embodiments, the consent information is a claim asserting that the resource owner consents, or does not consent, to the communication equipment accessing the protected resource of the API.

In some embodiments, the access token is an OAuth 2.0 access token.

In some embodiments, the API is a Northbound API.

In some embodiments, the communication equipment is a user equipment.

In some embodiments, the resource owner is a user of the communication equipment.

In some embodiments, the communication equipment is network equipment that implements an application function, AF.

In some embodiments, the access token also asserts that the communication equipment is authorized to access the API.

In some embodiments, the method further comprises performing the steps described above.

Other embodiments herein include a method performed by communication equipment configured to invoke an application programming interface, API, to access a service. The method comprises transmitting, from the communication equipment to common API core equipment, a request for an access token. The method also comprises receiving, in response to the request, an access token that indicates whether a resource owner consents to the communication equipment accessing a protected resource of the API.

In some embodiments, the access token includes consent information asserting that the resource owner consents, or does not consent, to the communication equipment accessing the protected resource of the API. In one or more of these embodiments, the consent information is a claim asserting that the resource owner consents, or does not consent, to the communication equipment accessing the protected resource of the API.

In some embodiments, the access token is an OAuth 2.0 access token.

In some embodiments, the API is a Northbound API.

In some embodiments, the communication equipment is a user equipment.

In some embodiments, the resource owner is a user of the communication equipment.

In some embodiments, the communication equipment is network equipment that implements an application function, AF.

In some embodiments, the access token also asserts that the communication equipment is authorized to access the API.

In some embodiments, the method further comprises, before transmitting the request for the access token, transmitting an authorization request to the common API core equipment. The method further comprises, before transmitting the request for the access token, receiving, in response to the authorization request, an authorization code that is a credential representing authorization of the resource owner. In some embodiments, the request for the access token includes the authorization code.

In some embodiments, the common API core equipment implements a CAPIF Core Function.

In some embodiments, the method further comprises performing the steps described above.

Other embodiments herein include a method performed by application programming interface, API, exposing equipment configured to expose an API to communication equipment. The method comprises receiving, from the communication equipment, a request to invoke the API. The method also comprises receiving, from the communication equipment, an access token that indicates whether a resource owner consents to the communication equipment accessing a protected resource of the API.

In some embodiments, the access token is included in the request.

In some embodiments, receiving the request and the access token comprises receiving, from the communication equipment, a message that includes both the request and the access token.

In some embodiments, receiving the access token comprises receiving the access token before, or at the same time as, receiving the request.

In some embodiments, the access token includes consent information asserting that the resource owner consents, or does not consent, to the communication equipment accessing the protected resource of the API. In one or more of these embodiments, the consent information is a claim asserting that the resource owner consents, or does not consent, to the communication equipment accessing the protected resource of the API.

In some embodiments, the access token is an OAuth 2.0 access token.

In some embodiments, the API is a Northbound API.

In some embodiments, the communication equipment is a user equipment.

In some embodiments, the resource owner is a user of the communication equipment.

In some embodiments, the communication equipment is network equipment that implements an application function, AF.

In some embodiments, the access token also asserts that the communication equipment is authorized to access the API.

In some embodiments, the access token includes one or more claims, including a claim asserting that the resource owner consents to the communication equipment accessing the protected resource of the API. The method further comprises verifying the request against the one or more claims in the access token. The method further comprises allowing or rejecting the request depending on said verifying.

In some embodiments, the method further comprises receiving, from common API core equipment, signaling indicating that the resource owner has revoked consent to the communication equipment accessing the protected resource of the API.

Other embodiments herein include a method performed by common application programming interface, API, core equipment. The method comprises receiving, from communication equipment, a request for an access token. The method also comprises transmitting, in response to the request, an access token that indicates whether a resource owner consents to the communication equipment accessing a protected resource of an API.

In some embodiments, the access token includes consent information asserting that the resource owner consents, or does not consent, to the communication equipment accessing the protected resource of the API. In one or more of these embodiments, the consent information is a claim asserting that the resource owner consents, or does not consent, to the communication equipment accessing the protected resource of the API.

In some embodiments, the access token is an OAuth 2.0 access token.

In some embodiments, the API is a Northbound API.

In some embodiments, the communication equipment is a user equipment.

In some embodiments, the resource owner is a user of the communication equipment.

In some embodiments, the communication equipment is network equipment that implements an application function, AF.

In some embodiments, the access token also asserts that the communication equipment is authorized to access the API.

In some embodiments, the method further comprises, before receiving the request for the access token receiving an authorization request from the communication equipment. The method further comprises, before receiving the request for the access token transmitting, in response to the authorization request, an authorization code to the communication equipment. In some embodiments, the request for the access token includes the authorization code. In some embodiments, the authorization code is a credential representing authorization of the resource owner. In one or more of these embodiments, the method further comprises responsive to receiving the authorization request, retrieving user consent parameters from unified data management, UDM, equipment. In some embodiments, the user consent parameters indicate whether the resource owner has granted consent to the communication equipment accessing the protected resource of the API. The method further comprises generating the authorization code based on the user consent parameters.

In some embodiments, the method further comprises, responsive to receiving the request for the access token, retrieving user consent parameters from unified data management, UDM, equipment. In some embodiments, the user consent parameters indicate whether the resource owner has granted consent to the communication equipment accessing the protected resource of the API. The method further comprises generating the access token based on the user consent parameters.

In some embodiments, the method further comprises subscribing to updates to user consent parameters from unified data management, UDM, equipment.

In some embodiments, the method further comprises receiving, from unified data management, UDM, equipment, notification that the resource owner has revoked consent to the communication equipment accessing the protected resource of the API. The method further comprises, based on the notification, transmitting, to API exposing equipment configured to expose the API, signaling indicating that the resource owner has revoked consent to the communication equipment accessing the protected resource of the API.

Other embodiments herein include a method performed by application programming interface, API, exposing equipment configured to expose an API to communication equipment. The method comprises receiving, from the communication equipment, a request to invoke the API. The method also comprises retrieving, from common API core equipment, one or more user consent parameters that indicate whether a resource owner consents to the communication equipment accessing a protected resource of the API.

In some embodiments, the one or more user consent parameters are retrieved from the common API core equipment in response to transmitting a request for the one or more user consent parameters to the common API core equipment.

In some embodiments, the one or more user consent parameters are retrieved from the common API core equipment along with authorization information indicating whether or not the communication equipment is authorized to access the API.

In some embodiments, the one or more user consent parameters are retrieved after and/or responsive to receiving the request.

In some embodiments, the API is a Northbound API.

In some embodiments, the communication equipment is a user equipment.

In some embodiments, the resource owner is a user of the communication equipment.

In some embodiments, the communication equipment is network equipment that implements an application function, AF.

In some embodiments, the method further comprises allowing or rejecting the request depending on whether the resource owner consents to the communication equipment accessing the protected resource of the API.

Other embodiments herein include a method performed by common application programming interface, API, core equipment. The method comprises receiving, from API exposing equipment, a request for one or more user consent parameters that indicate whether a resource owner consents to a communication equipment accessing a protected resource of an API. The method further comprises transmitting the one or more user consent parameter to the API exposing equipment in response to the request.

In some embodiments, the method further comprises retrieving the one or more user consent parameters from user data management, UDM, equipment responsive to receiving the request.

In some embodiments, the API is a Northbound API.

In some embodiments, the communication equipment is a user equipment.

In some embodiments, the resource owner is a user of the communication equipment.

In some embodiments, the communication equipment is network equipment that implements an application function, AF.

In some embodiments, the one or more user consent parameters are transmitted along with authorization information indicating whether or not the communication equipment is authorized to access the API.

Embodiments herein also include corresponding apparatus, computer programs, and carriers of those computer programs.

### BRIEF DESCRIPTION OF THE DRAWINGS

FIG. 1 is a block diagram of a communication network according to some embodiments that exploit an access token for indicating resource owner consent.

FIG. 2 is a block diagram of a common API framework architecture according to some embodiments.

FIG. 3 is a call flow diagram of a procedure for API invocation according to some embodiments.

FIG. 4 is a call flow diagram for authentication of an API invocation request according to some embodiments.

FIG. 5A is a call flow diagram of a procedure for acquiring an OAuth 2.0 access token that accounts for user consent according to some embodiments.

FIG. 5B is a call flow diagram of a procedure for acquiring an OAuth 2.0 access token that accounts for user consent according to other embodiments.

FIG. 5C is a call flow diagram of a procedure for API invocation request authentication accounting for user consent according to some embodiments that use an OAuth 2.0 access token.

FIG. 5D is a call flow diagram of a procedure for revoking user consent according to some embodiments that use an OAuth 2.0 access token.

FIG. 6 is a block diagram of a communication network according to some embodiments that do not exploit an access token for indicating resource owner consent.

FIG. 7 is a call flow diagram of a procedure for API invocation request authentication accounting for user consent according to some embodiments in which the API exposing function retrieves user consent parameter(s) from the CAPIF core function.

FIG. 8A is a logic flow diagram of a method performed by communication equipment according to some embodiments that exploit an access token for indicating resource owner consent.

FIG. 8B is a logic flow diagram of a method performed by API exposing equipment according to some embodiments that exploit an access token for indicating resource owner consent.

FIG. 8C is a logic flow diagram of a method performed by common API core equipment according to some embodiments that exploit an access token for indicating resource owner consent.

FIG. 9A is a logic flow diagram of a method performed by API exposing equipment according to some embodiments that do not exploit an access token for indicating resource owner consent.

FIG. 9B is a logic flow diagram of a method performed by common API core equipment according to some embodiments that do not exploit an access token for indicating resource owner consent.

FIG. 10 is a block diagram of communication equipment according to some embodiments.

FIG. 11 is a block diagram of API exposing equipment according to some embodiments.

FIG. 12 is a block diagram of common API core equipment according to some embodiments.

FIG. 13 is a block diagram of a communication system in accordance with some embodiments.

FIG. 14 is a block diagram of a user equipment according to some embodiments.

FIG. 15 is a block diagram of a network node according to some embodiments.

FIG. 16 is a block diagram of a host according to some embodiments.

FIG. 17 is a block diagram of a virtualization environment according to some embodiments.

FIG. 18 is a block diagram of a host communicating via a network node with a UE over a partially wireless connection in accordance with some embodiments.

### DETAILED DESCRIPTION

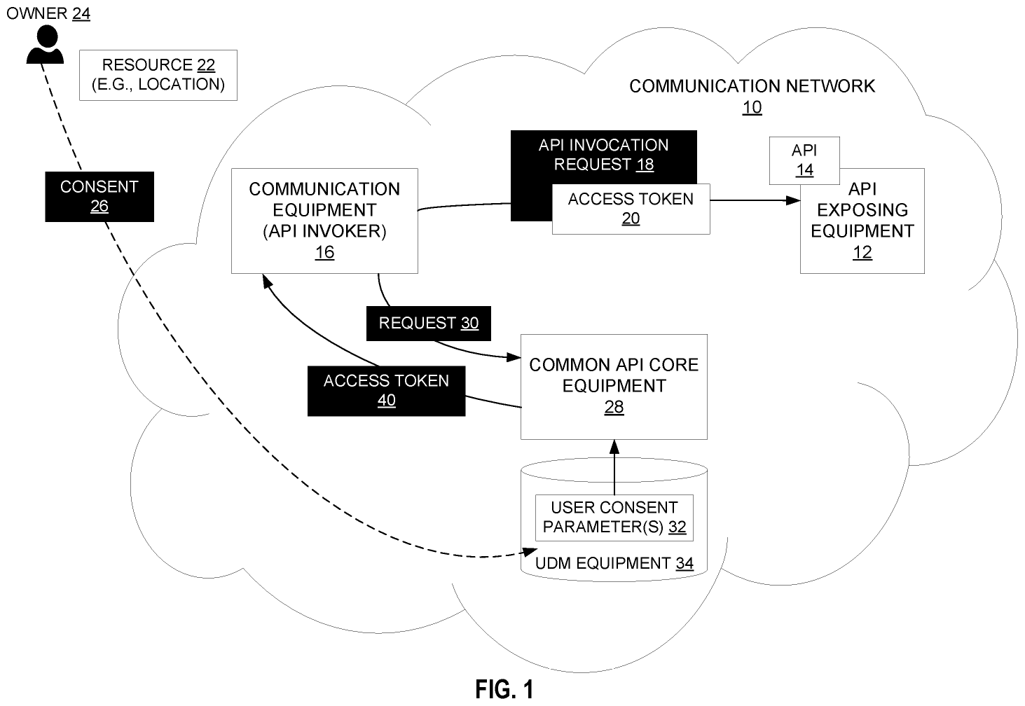

FIG. 1 shows a communication network 10 according to some embodiments, e.g., in the form of a 5G network. The communication network 10 has a service-based architecture that leverages service-based interactions between entities of the communication network 10. Entities in the communication network 10 thereby offer services to other entities, for example, by exposing respective application programming interfaces (APIs) for those services.

As shown in this regard, the communication network 10 includes API exposing equipment 12, e.g., implementing an API Exposing Function (AEF). The API exposing equipment 12 exposes an API 14 for a service offered by the API exposing equipment 12. In embodiments where the API 14 is exposed to higher-layer entities, the API 14 may be a so-called Northbound API. Regardless, via this API 14, other entities in the communication network 10 can access the service.

FIG. 1 for instance shows one entity as being communication equipment 16. The communication equipment 12 may for instance be a communication device, e.g., a user equipment, or may be network equipment, e.g., that implements an application function (AF). The communication equipment 16 as shown transmits an API invocation request 18 to the API exposing equipment 12. The API invocation request 18 is a request to invoke the API 14 and thereby access the service. Communication equipment 16 may therefore appropriately be referred to as an API invoker.

According to some embodiments, though, the API exposing equipment 12 controls access to the API 14, such that only invocation requests from authorized entities are authorized and allowed. The API exposing equipment 12 as shown in this regard controls access to the API 14 by the communication equipment 16 on the basis of an access token 20, e.g., an OAuth 2.0 token.

The communication equipment 16 in particular transmits the access token 20 to the API exposing equipment 12. The access token 20 may for example be transmitted along with or otherwise in association with the API invocation request 18, e.g., the access token 20 may be included in the API invocation request 18 itself or included in the same message as the API invocation request 18. In these and other embodiments, then, the communication equipment 16 may transmit the access token 20 to the API exposing equipment 12 before, or at the same time as, transmitting the API invocation request 18. Regardless, the access token 20 may assert (e.g., via a claim) that the communication equipment 16 is authorized to access the API 14. Upon receipt of the access token 20, the API exposing equipment 12 verifies or validates the access token 20, as part of a decision of whether to allow or reject the API invocation request 18.

According to embodiments herein, however, the API 14 includes one or more operations that, when invoked, act upon a protected resource 22. The protected resource 22 is protected in the sense that the resource is protected from being acted upon without the consent 26 of the owner 24 of the resource (also referred to as the resource owner 24). For example, the protected resource 22 may be the location of a user, in which case the user's location is protected from being acted upon by the API 14 without the consent of the user. Accordingly, even if the access token 20 would otherwise authorize the communication equipment 16 to invoke the API 14 generally, the communication equipment 16 should still not be able to invoke one or more operations of the API 14 that act upon the protected resource 22 unless the owner 24 has consented to the communication equipment 16 doing so.

Notably, some embodiments herein exploit the access token 20 for indicating whether the resource owner 24 consents 26 to the communication equipment 16 accessing the protected resource 22 of the API 14, e.g., in addition to the access token 20 indicating whether the communication equipment 16 is authorized to access the API 14. In one embodiment, for instance, the access token 20 includes consent information asserting that the resource owner 24 consents (or does not consent) to the communication equipment 16 accessing the protected resource 22 of the API 14, e.g., where the consent information may be a claim of the access token 20. Regardless, in embodiments where the access token 20 indicates whether the communication equipment 16 is authorized to access the API 14, then, some embodiments re-use the access token 20 to also indicate whether the resource owner 24 consents 26 to the communication equipment 16 accessing the protected resource 22 of the API 14.

Note that resource owner 24 consent 26 to the communication equipment 16 accessing the protected resource 22 may also be referred to as resource owner 24 authorization for the communication equipment 16 to access the protected resource 22, i.e., resource owner consent may be used interchangeably with resource owner authorization.

Advantageously, by exploiting the access token 20 in this way, steps for authorizing access to the API 14 by the communication equipment 16 can be efficiently avoided or aborted if the access token 20 indicates the resource owner 24 has not consented to the communication equipment 16 accessing the protected resource 22. By exploiting the access token 20 in this way, then, some embodiments herein provide a way to invoke the API 14 for access to the protected resource 22 in a way that is efficient from a signaling and processing perspective.

More particularly, in some embodiments, the communication equipment 16 obtains an access token 40 from common API core equipment 28, e.g., implementing a Common API Framework (CAPIF) Core Function. As shown in this regard, communication equipment 16 transmits, to the common API core equipment 28, a request 30 for the access token 40. The common API core equipment 28 generates or retrieves the requested access token 40 and transmits the access token 40 back to the communication equipment 16, so that the communication equipment 16 can present the access token 20 to the API exposing equipment 12.

In one embodiment, the common API core equipment 28 generates the access token 40 based on user consent parameter(s) 32 retrieved from unified data management (UDM) equipment 34 responsive to receiving the request 30 for the access token 40. Such user consent parameter(s) 32 in this case may indicate whether the resource owner 24 has granted consent 26 to the communication equipment 16 accessing the protected resource 22 of the API 14. With the user consent parameter(s) 32 being stored in the UDM equipment 34, this means that the indication of whether the resource owner 24 has granted consent 26 to the communication equipment 16 accessing the protected resource 22 of the API 14 may be a part of subscriber information in the communication network 10, e.g., so as to be stored as part of the subscriber information at the UDM equipment 34.

In other embodiments, the common API core equipment 28 generates the access token 40 based on an authorization code that the common API core equipment 28 in turn generates based on the user consent parameter(s) 32. In particular, before transmitting the request 30 for the access token 40, the communication equipment 16 transmits an authorization request (not shown) to the common API core equipment 28. Responsive to receiving the authorization request, the common API core equipment 28 generates an authorization code based on the user consent parameter(s) 32, such that the authorization code is a credential representing authorization of the resource owner 24. See, e.g., section 1.2 of OAuth 2.0 RFC 6749. The common API core equipment 28 transmits the authorization code to the communication equipment 16. The communication equipment 16 thereafter transmits the request 30 for the access token 40 to the common API core equipment 28, with the request 30 including the previously received authorization code. The common API core equipment 28 correspondingly generates the requested access token 40 based on the authorization code included in the request 30.

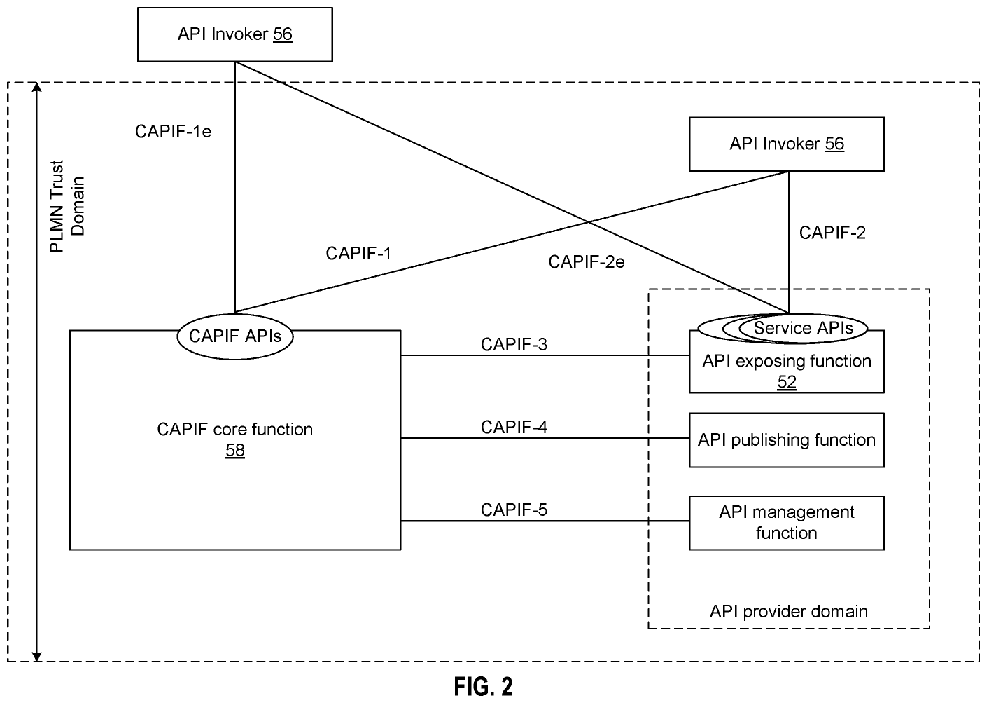

The embodiments shown in FIG. 1 may be applicable in an example context where the communication network has a Common API Framework (CAPIF) architecture. CAPIF architecture, procedures and information flows are specified in 3GPP TS 23.222 v17.5.0. FIG. 2 depicts the functional model for the CAPIF, e.g., consistent with section 6.2.0-1 in TS 23.222 v17.5.0. According to this example context, the communication equipment 16 corresponds to the API Invoker 56, the API exposing equipment 12 corresponds to an API Exposing Function (AEF) 52, and the common API core equipment 28 corresponds to the CAPIF Core Function 58.

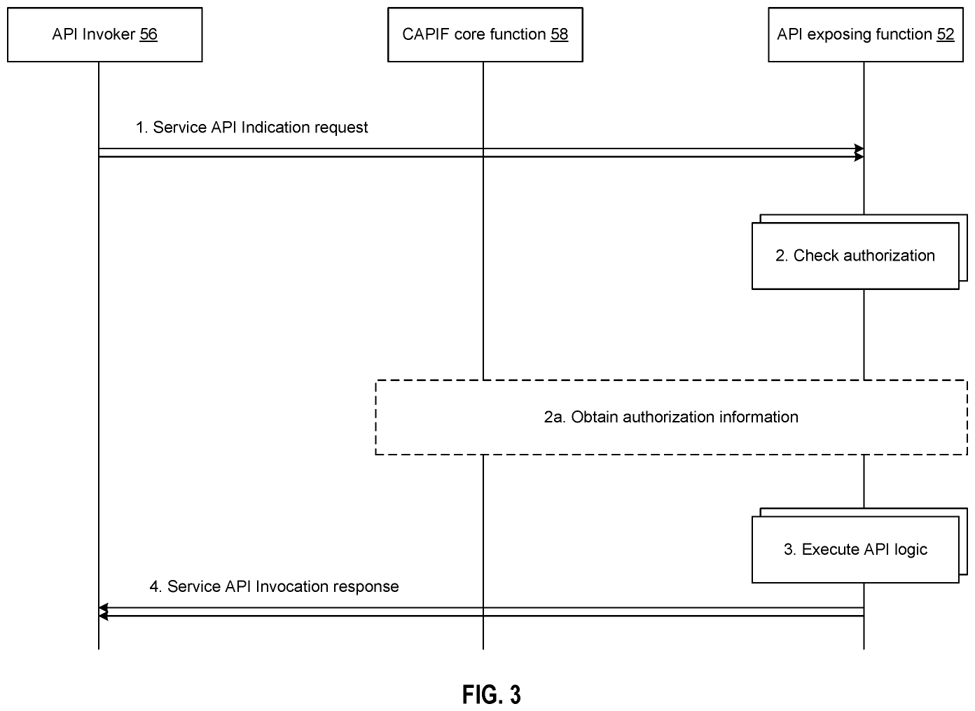

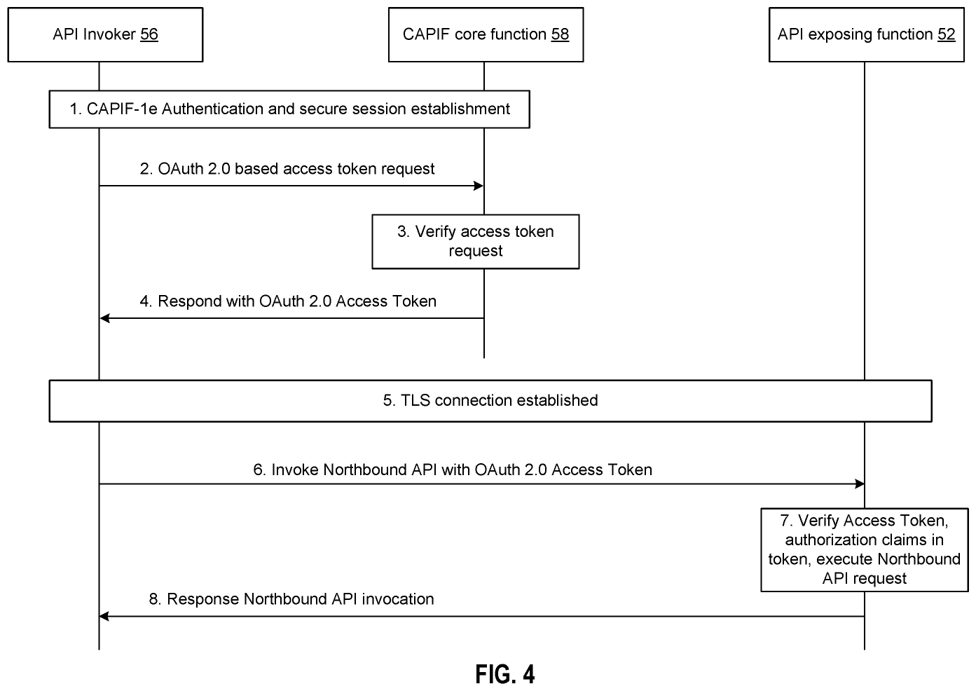

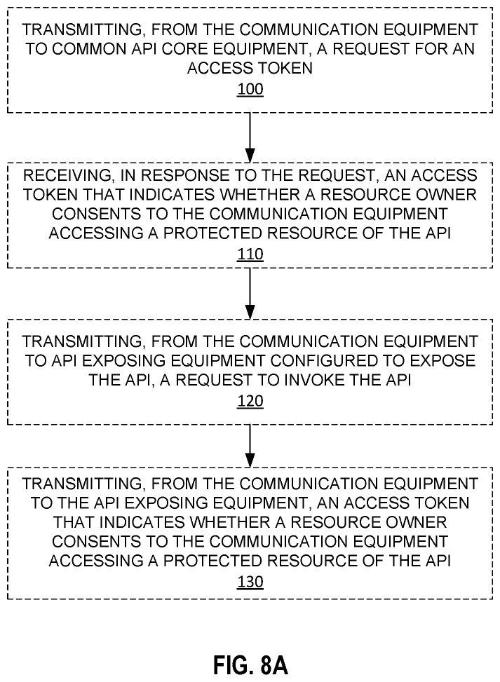

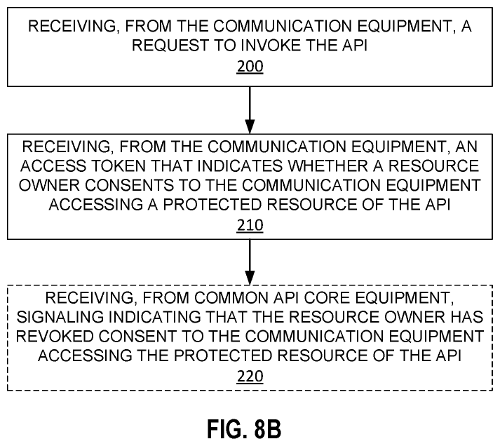

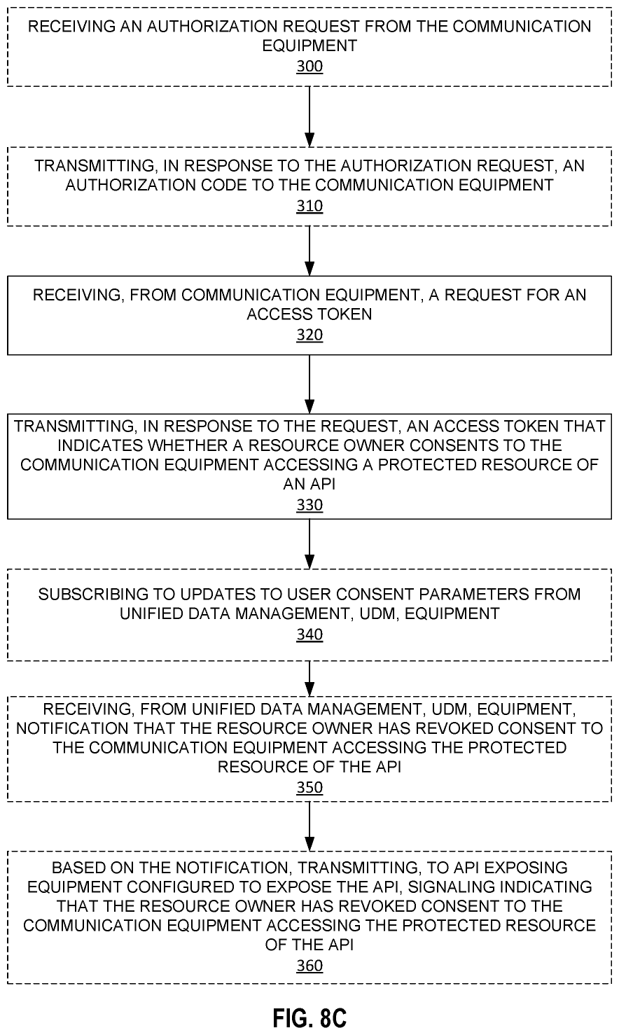

According to the security architecture for the CAPIF, e.g., as specified in 3GPP TS 33.122, the API invoker 56 is authorized by the API Exposing Function (AEF). FIG. 3 shows the high-level mechanism for this authorization, e.g., consistent with TS 23.222 v17.5.0 clause 8.16, FIG. 8.16.3-1, and TS 33.122 v16.3.0 clause 6.5. According to this procedure, the API invoker 56 may provide authorization information in step 1. If not provided, then AEF 52 fetches the authorization information from the CAPIF Core Function (CCF). The OAuth 2.0 protocol may be used for the first case (the case where the API invoker 56 provides the authorization information). In that procedure, the CCF play the authorization server role, the API invoker 56 plays the client role, and the API invoker 56 plays the resource server role where the authorization server, client and resource server roles are defined in OAuth 2.0 framework. FIG. 4 shows the procedure where the OAuth access token is used.

Some embodiments herein exploit this OAuth access token for user consent purposes in CAPIF, e.g., as specified in 3GPP TS 33.501 17.5.0 Annex V. In this case, the Unified Data Management (UDM)/Unified Data Repository (UDR) stores user consent related parameters which are bounded to a Subscription Permanent Identifier (SUPI)/Generic Public Subscription Identifier (GPSI). Also, the UDM supports the services of retrieval of user consent parameters and notification of user consent parameters change. A Network Function (NF) that is deemed an enforcement point for user consent shall support to retrieve the user consent parameters from the UDM. Since user consent can be revoked in time, the NF shall support subscription to the user consent parameter change notification provided by the UDM. Then the UDM notifies the subscriber NFs about the user consent revocation. Also, any enforcement point NF may notify other NFs to halt the processing of the data subject to the revoked user consent.

According to some embodiments herein in the context of CAPIF, the CCF may fetch user consent information from UDM directly or via another function and include this information into the OAuth 2.0 access token. This way, the user consent check may be done before or during the API invoker authorization. When there is no user consent, then the steps about authorization can be avoided or aborted. Moreover, some embodiments provide consent information revocation in CCF event subscription and notification, event service consumer is AEF 52.

Certain embodiments may provide one or more of the following technical advantage(s). Some embodiments advantageously optimize the procedure of checking the authorization and user consent for the northbound API calls.

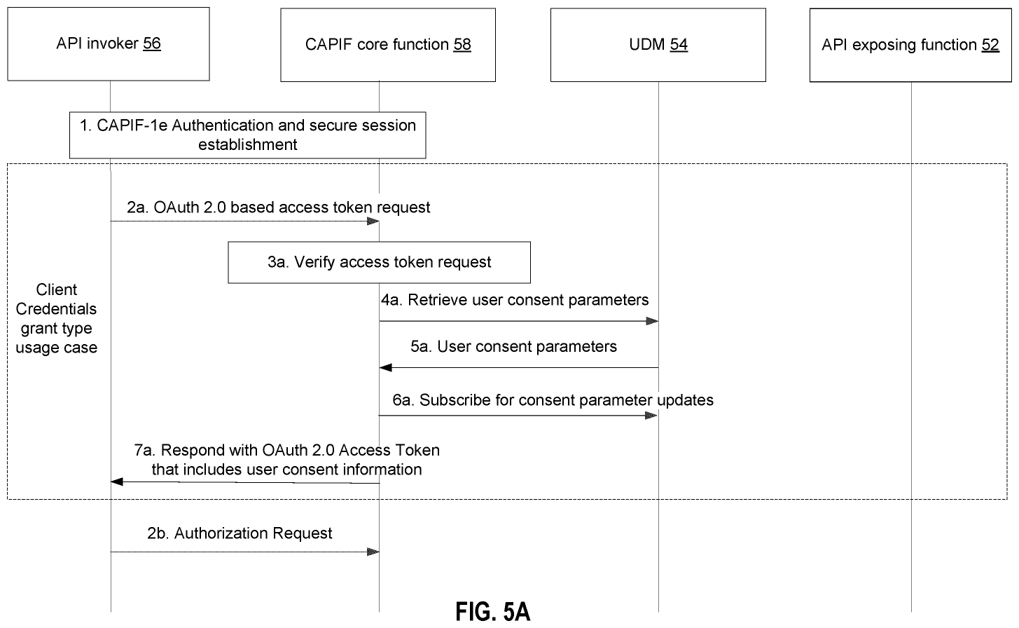

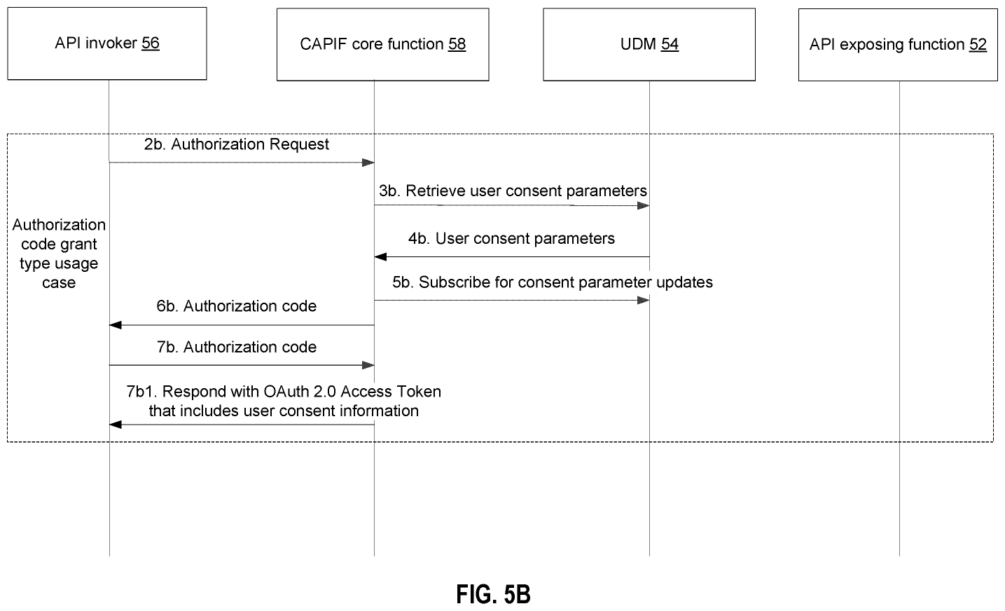

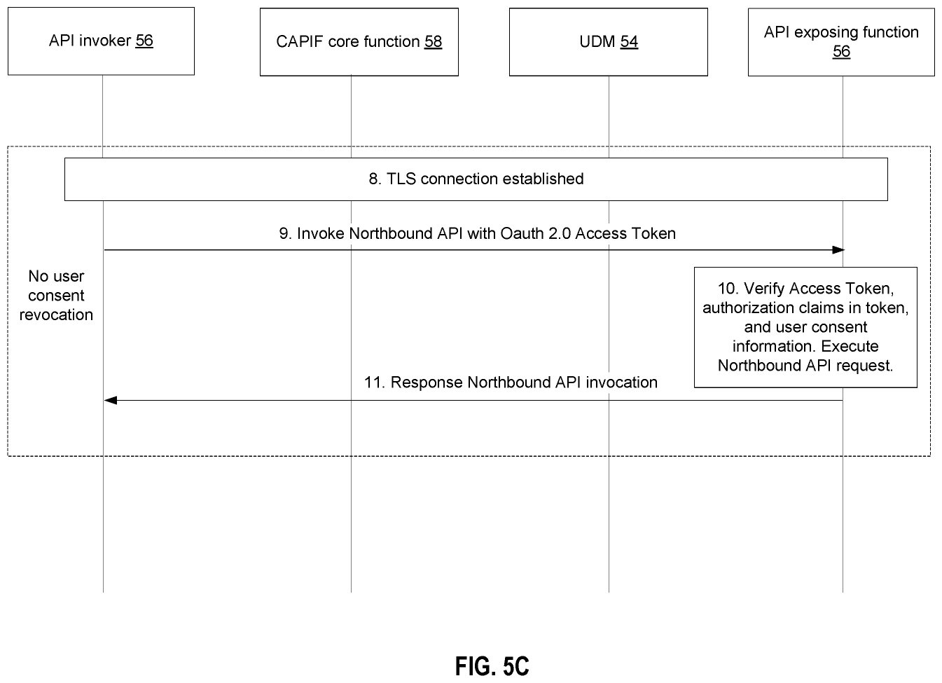

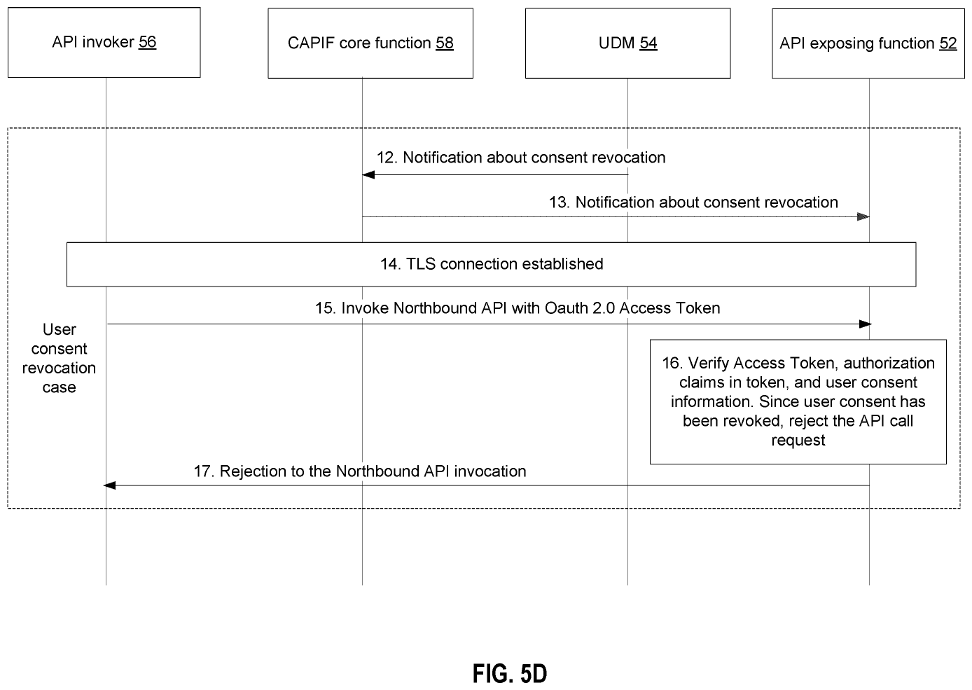

FIGS. 5A-5D show one example of some embodiments in the CAPIF context for the case that OAuth access token is used.

The steps are explained as follows:

Step 1: The API invoker 56 and the CCF execute authentication procedures and establish a secure channel.

NOTE: Depending on the “Option #1” and “Option #2” (Authorization code grant type usage for the OAuth protocol), either steps 2a-7a or steps 2b-7b1 are performed.

Step 2a: The API invoker 56 requests Oauth access token from the CCF. Here, the request in Step 2a exemplifies the request 30 for the access token 40 in FIG. 1.

Step 3a: The CCF verifies the request.

Step 4a: The CCF fetches user consent parameters from the UDM directly or via another function (e.g., NEF). Here, the user consent parameters exemplify the user consent parameter(s) 32 in FIG. 1.

Step 5a: The UDM sends the user consent parameters to the CCF directly or via another function (e.g., NEF).

Step 6a: The CCF subscribes to the UDM directly or via another function (e.g. NEF) for the changes on the user consent parameters.

NOTE: Step 6a can be executed in arbitrary time such as before Step 4a or after Step 7a.

Step 7a: The CCF issues an access token that includes the user consent related information, where the access token exemplifies the access token 20 in FIG. 1. The user consent related information may be, or include, the consent information described in FIG. 1, asserting that the user consents (or does not consent) to access to a protected resource, e.g., where the user consent related information may be a claim of the access token. In some embodiments, the access token and/or the user consent related information is bound to the API invoker 56, e.g., where the API invoker 56 is a UE the access token and/or the user consent related information may include a UE identity (ID) identifying the UE. The CCF sends the issued token to the API invoker 56.

Step 2b: The API invoker 56 sends an authorization request to the CCF.

Step 3b: The CCF fetches user consent parameters from the UDM directly or via another function (e.g., NEF).

Step 4b: The UDM sends the user consent parameters to the CCF directly or via another function (e.g., NEF).

Step 5b: The CCF subscribes to the UDM directly or via another function (e.g., NEF) for the changes on the user consent parameters.

NOTE: Step 5b can be executed in arbitrary time such as before Step 3b or after Step 6b.

Step 6b: The CCF creates an authorization code if the authorization is successful, and sends it to the API invoker 56.

Step 7b: The API invoker 56 sends the received authorization code to the CCF in the access token request. Here, the access token request in Step 7b exemplifies the request 30 for the access token 40 in FIG. 1.

Step 7b1: If authorization code check is successful then the CCF issues an access token that includes the user consent related information, where the access token exemplifies the access token 20 in FIG. 1. The CCF sends the issues token to the API invoker 56.

NOTE: Steps 8-11 shows the procedure for the case that the user consent has not been revoked before the API call request.

Step 8: The API invoker 56 and AEF 52 executes some authentication and establish a secure channel using TLS.

Step 9: The API invoker 56 sends the access token in the Northbound API call. Here, the Northbound API call exemplifies the API invocation request 18 in FIG. 1, and the access token included in the Northbound API call exemplifies the access token 20 in FIG. 1.

Step 10: The AEF 52 verifies the access token, checks the authorization information and user consent related information. If authorization is granted by the CCF and user consent information implies that user consent has been granted, then the AEF 52 processes the request.

Step 11: The AEF sends the response.

NOTE: Steps 12-17 shows the procedure for the case that the user consent has been revoked before the API call request.

Step 12: The CCF receives a notification about user consent revocation.

Step 13: The CCF informs the AEF about the revocation. (The AEF has subscribed CCF event exposure service which is not depicted in the figure) Step 14: The API invoker 56 and AEF executes some authentication and establish a secure channel using TLS.

Step 15: The API invoker 56 sends the access token in the Northbound API call.

Step 16: The AEF verifies the access token, checks the authorization information and user consent related information. Since the user consent has been revoked, the AEF rejects the request.

Step 17: The AEF sends the rejection to the API invoker 56.

NOTE: If the user consent parameter received in Step 5a and 4b implies that there is no user consent, then the CCF may not issue a token/authorization code instead of issuing a token including the information that there is no user consent. Then the procedure ends with sending a rejection to the API invoker 56 by the CCF.

For the token generated in step 7a and 7b1 by CCF, the additional authorization information (i.e., user consent info) is a new information element to be specified in the token claim (e.g., defined in AccessTokenClaims data type in TS 29.510). Such authorization information may include an indication indicating whether the user grants the access for the protected resource.

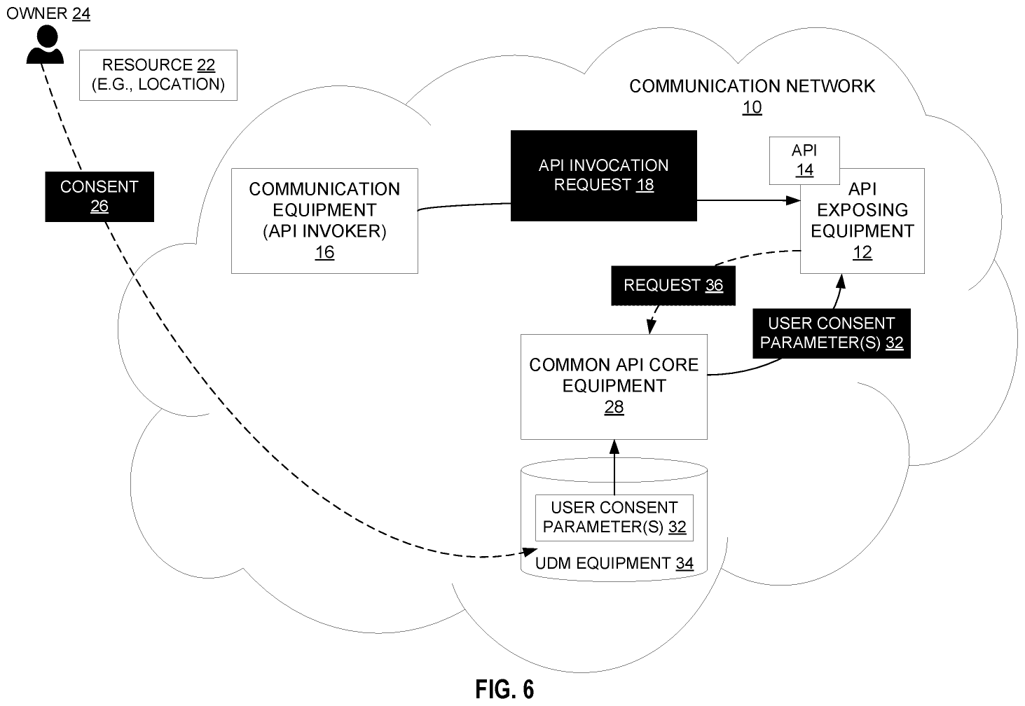

FIG. 6 illustrates still other embodiments herein. Rather than exploiting an access token as in FIG. 1, these embodiments incorporate retrieval of the user consent parameter(s) 32 into the API invocation procedure. As shown in FIG. 6 in this regard, the API exposing equipment 12 retrieves the user consent parameter(s) 32 from the common API core equipment 28, e.g., responsive to transmitting a request 36 for such user consent parameter(s) 34 to the common API core equipment 28. The API exposing equipment 12 may for instance retrieve the user consent parameter(s) 32 in this way upon or after receiving the API invocation request 18 from the communication equipment 16. In these and other embodiments, the user consent parameter(s) 32 may be retrieved from the common API core equipment 28 along with authorization information indicating whether or not the communication equipment 16 is authorized to access the API 14. In any event, the API exposing equipment 12 may then allow or reject the API invocation request 18 depending on whether the resource owner 24 consents 26 to the communication equipment 16 accessing the protected resource 22 of the API 14 according to the user consent parameter(s) 32.

Note that, in some embodiments as shown, the common API core equipment 28 retrieves the user consent parameter(s) 32 from the UDM equipment 34, e.g., responsive to receiving a request 36 for the user consent parameter(s) 32 from the API exposing equipment 12.

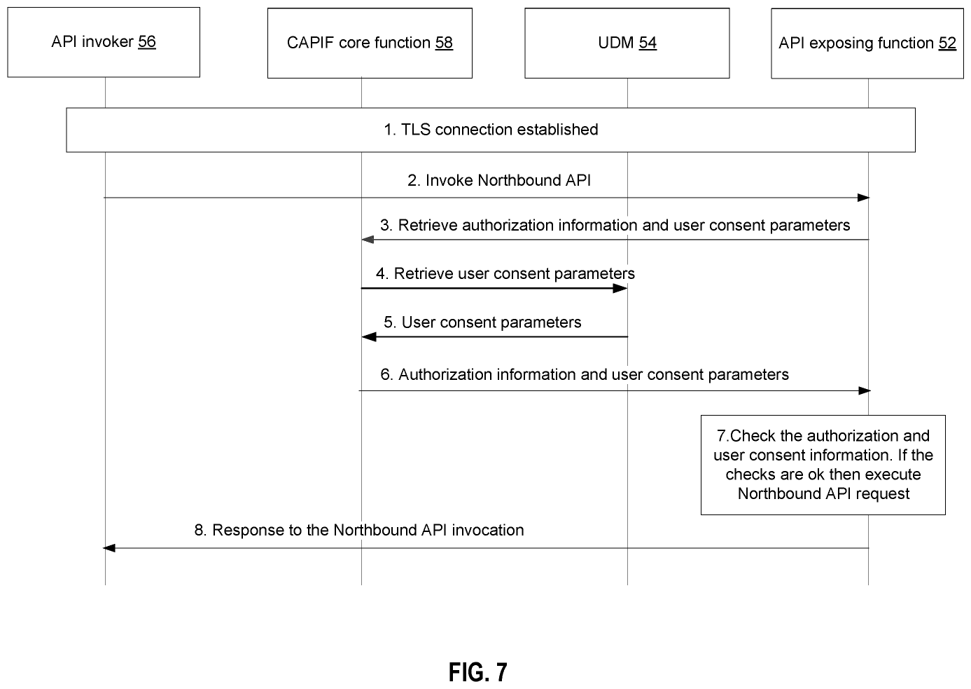

Consider an example in the context of the CAPIF. In this example, where Auth 2.0 is not used and authorization information is received from the CCF by the AEF, the CCF fetches the user consent information from the UDM directly or via another function and includes this information into the authorization information sent to the AEF. That is, the User consent information fetched from the UDM directly or via another function by the CCF is added to authorization information sent from CCF to AEF. Here, the user consent information may correspond to the user consent parameter(s) 32. FIG. 7 shows additional details according to one example, where the communication equipment 16 corresponds to the API Invoker 56, the API exposing equipment 12 corresponds to an API Exposing Function (AEF) 52, and the common API core equipment 28 corresponds to the CAPIF Core Function 58.

The steps are explained as follows:

Step 1: The API invoker 56 and AEF executes some authentication and establish a secure channel using TLS.

Step 2: The API invoker 56 invokes the Northbound API.

Step 3: The AEF request authorization and user consent related information from the CCF.

Step 4: The CCF fetches user consent parameters from the UDM directly or via another function (e.g., NEF).

Step 5: The UDM send the user consent parameters to the CCF directly or via another function (e.g., NEF).

Step 6: The CCF sends the authorization and user consent related information to the AEF. The user consent related information may be, or include, the consent information described in FIG. 1, asserting that the user consents (or does not consent) to access to a protected resource.

Step 7: The AEF check whether the API invoker 56 is authorized to call the API using the authorization information received from the CCF and also checks the user consent information whether consent is granted. If both checks implies that the API invoker 56 is authorized and there is a user consent, then the AEF process the request.

Step 8: The AEF send the process request to the API invoker 56.

In view of the modifications and variations herein, FIG. 8A depicts a method in accordance with particular embodiments. The method is performed by communication equipment 16 configured to invoke an application programming interface, API, to access a service.

In some embodiments, the method includes transmitting, from the communication equipment 16 to common API core equipment, a request 18 for an access token 40 (Block 100). The method may also include receiving, in response to the request 18, an access token 20 that indicates whether a resource owner 24 consents to the communication equipment 16 accessing a protected resource 22 of the API 14 (Block 110).

In some embodiments, the method alternatively or additionally includes transmitting, from the communication equipment 16 to API exposing equipment 12 configured to expose the API 14, a request 18 to invoke the API 14 (Block 120). The method may also include transmitting, from the communication equipment 16 to the API exposing equipment 12, an access token 20 that indicates whether a resource owner 24 consents to the communication equipment 16 accessing a protected resource 22 of the API (Block 130).

FIG. 8B depicts a method in accordance with other particular embodiments. The method is performed by application programming interface, API, exposing equipment 12 configured to expose an API 14 to communication equipment 16. The method includes receiving, from the communication equipment 16, a request 18 to invoke the API 14 (Block 200). The method also includes receiving, from the communication equipment 16, an access token 20 that indicates whether a resource owner 24 consents to the communication equipment 16 accessing a protected resource 22 of the API 14 (Block 210).

The method in some embodiments also includes receiving, from common API core equipment 28, signaling indicating that the resource owner 24 has revoked consent to the communication equipment 16 accessing the protected resource 22 of the API (Block 220).

FIG. 8C depicts a method in accordance with other particular embodiments. The method is performed by common application programming interface, API, core equipment 28. The method includes receiving, from communication equipment 16, a request 30 for an access token 40 (Block 320). The method also includes transmitting, in response to the request 30, an access token 20 that indicates whether a resource owner 24 consents to the communication equipment 16 accessing a protected resource 22 of an API (Block 330).

In some embodiments, the method also includes receiving an authorization request from the communication equipment 16 (Block 300). The method in this case also includes transmitting, in response to the authorization request, an authorization code to the communication equipment 16 (Block 310). In one such embodiment, the request 30 for the access token 40 received in Block 320 includes the authorization code.

Regardless, in some embodiments, the method also includes subscribing to updates to user consent parameter(s) 32 from unified data management, UDM, equipment 34 (Block 340).

Alternatively or additionally, the method in some embodiments includes receiving, from unified data management, UDM, equipment 34, notification that the resource owner 24 has revoked consent to the communication equipment 16 accessing the protected resource 22 of the API (Block 350). In such a case, the method may also include, based on the notification, transmitting, to API exposing equipment 12 configured to expose the API, signaling indicating that the resource owner 24 has revoked consent to the communication equipment 16 accessing the protected resource 22 of the API (Block 360).

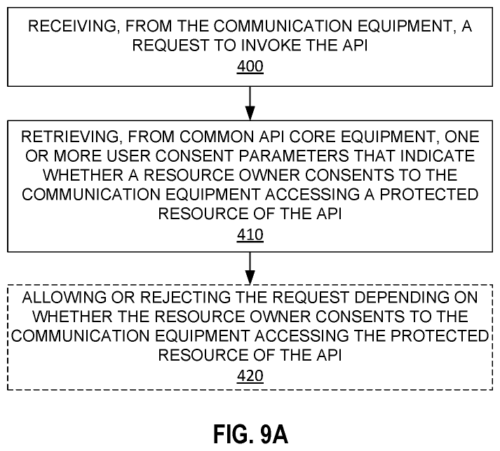

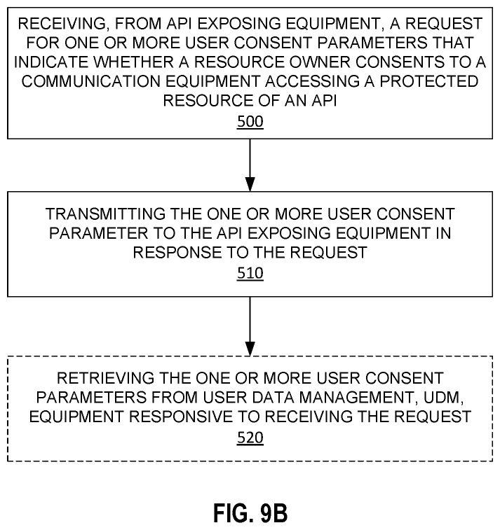

FIG. 9A depicts a method in accordance with other particular embodiments. The method is performed by application programming interface, API, exposing equipment 12 configured to expose an API 14 to communication equipment 16. The method includes receiving, from the communication equipment 16, a request 18 to invoke the API (Block 400). The method also includes retrieving, from common API core equipment 28, one or more user consent parameters 32 that indicate whether a resource owner 24 consents to the communication equipment 16 accessing a protected resource 22 of the API (Block 410).

In some embodiments, the method also includes allowing or rejecting the request 18 depending on whether the resource owner 24 consents to the communication equipment 16 accessing the protected resource 22 of the API (Block 420).

FIG. 9B depicts a method in accordance with other particular embodiments. The method is performed by common application programming interface, API, core equipment 28. The method includes receiving, from API exposing equipment 12, a request 36 for one or more user consent parameters 32 that indicate whether a resource owner 24 consents to a communication equipment 16 accessing a protected resource 22 of an API (Block 500). The method also includes transmitting the one or more user consent parameter 32 to the API exposing equipment 12 in response to the request (Block 510).

In some embodiments, the method also includes retrieving the one or more user consent parameters 32 from user data management, UDM, equipment 34 responsive to receiving the request 36 (Block 520).

Embodiments herein also include corresponding apparatuses. Embodiments herein for instance include communication equipment 16 configured to perform any of the steps of any of the embodiments described above for the communication equipment 16.

Embodiments also include communication equipment 16 comprising processing circuitry and power supply circuitry. The processing circuitry is configured to perform any of the steps of any of the embodiments described above for the communication equipment 16. The power supply circuitry is configured to supply power to the communication equipment 16.

Embodiments further include communication equipment 16 comprising processing circuitry. The processing circuitry is configured to perform any of the steps of any of the embodiments described above for the communication equipment 16. In some embodiments, the communication equipment 16 further comprises communication circuitry.

Embodiments further include communication equipment 16 comprising processing circuitry and memory. The memory contains instructions executable by the processing circuitry whereby the communication equipment 16 is configured to perform any of the steps of any of the embodiments described above for the communication equipment 16.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication equipment 16. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include API exposing equipment 12 configured to perform any of the steps of any of the embodiments described above for the API exposing equipment 12.

Embodiments also include API exposing equipment 12 comprising processing circuitry and power supply circuitry. The processing circuitry is configured to perform any of the steps of any of the embodiments described above for the API exposing equipment 12. The power supply circuitry is configured to supply power to the API exposing equipment 12.

Embodiments further include API exposing equipment 12 comprising processing circuitry. The processing circuitry is configured to perform any of the steps of any of the embodiments described above for the API exposing equipment 12. In some embodiments, the API exposing equipment 12 further comprises communication circuitry.

Embodiments further include API exposing equipment 12 comprising processing circuitry and memory. The memory contains instructions executable by the processing circuitry whereby the API exposing equipment 12 is configured to perform any of the steps of any of the embodiments described above for the API exposing equipment 12.

Embodiments herein further include common API core equipment 28 configured to perform any of the steps of any of the embodiments described above for the common API core equipment 28.

Embodiments also include common API core equipment 28 comprising processing circuitry and power supply circuitry. The processing circuitry is configured to perform any of the steps of any of the embodiments described above for the common API core equipment 28. The power supply circuitry is configured to supply power to the common API core equipment 28.

Embodiments further include common API core equipment 28 comprising processing circuitry. The processing circuitry is configured to perform any of the steps of any of the embodiments described above for the common API core equipment 28. In some embodiments, the common API core equipment 28 further comprises communication circuitry.

Embodiments further include common API core equipment 28 comprising processing circuitry and memory. The memory contains instructions executable by the processing circuitry whereby the common API core equipment 28 is configured to perform any of the steps of any of the embodiments described above for the common API core equipment 28.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

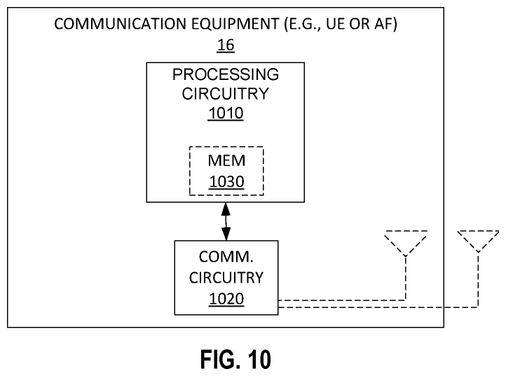

FIG. 10 for example illustrates communication equipment 16 as implemented in accordance with one or more embodiments. As shown, the communication equipment 16 includes processing circuitry 1010 and communication circuitry 1020. The communication circuitry 1020 (e.g., radio circuitry) is configured to transmit and/or receive information to and/or from one or more other nodes, e.g., via any communication technology. Such communication may occur via one or more antennas that are either internal or external to the communication equipment 16, e.g., in the case that the communication equipment 16 is wireless communication equipment such as a user equipment. Regardless, the processing circuitry 1010 is configured to perform processing described above, e.g., in FIG. 9A, such as by executing instructions stored in memory 1030. The processing circuitry 1010 in this regard may implement certain functional means, units, or modules.

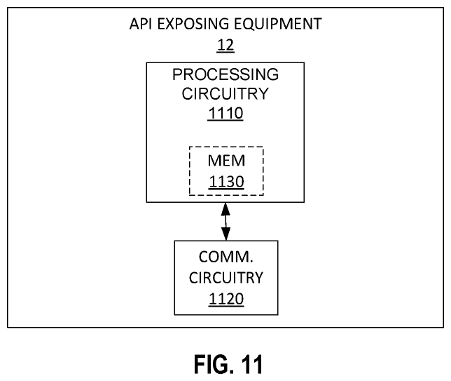

FIG. 11 illustrates API exposing equipment 12 as implemented in accordance with one or more embodiments. As shown, the API exposing equipment 12 includes processing circuitry 1110 and communication circuitry 1120. The communication circuitry 1120 is configured to transmit and/or receive information to and/or from one or more other nodes, e.g., via any communication technology. The processing circuitry 1110 is configured to perform processing described above, e.g., in FIGS. 9B and/or 10A, such as by executing instructions stored in memory 1130. The processing circuitry 1110 in this regard may implement certain functional means, units, or modules.

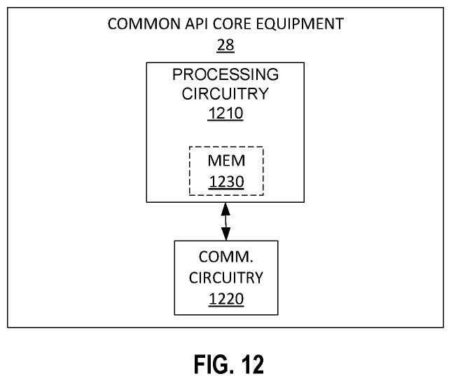

FIG. 12 illustrates common API core equipment 28 as implemented in accordance with one or more embodiments. As shown, the common API core equipment 28 includes processing circuitry 1210 and communication circuitry 1220. The communication circuitry 1220 is configured to transmit and/or receive information to and/or from one or more other nodes, e.g., via any communication technology. The processing circuitry 1210 is configured to perform processing described above, e.g., in FIGS. 9C and/or 10B, such as by executing instructions stored in memory 1230. The processing circuitry 1210 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

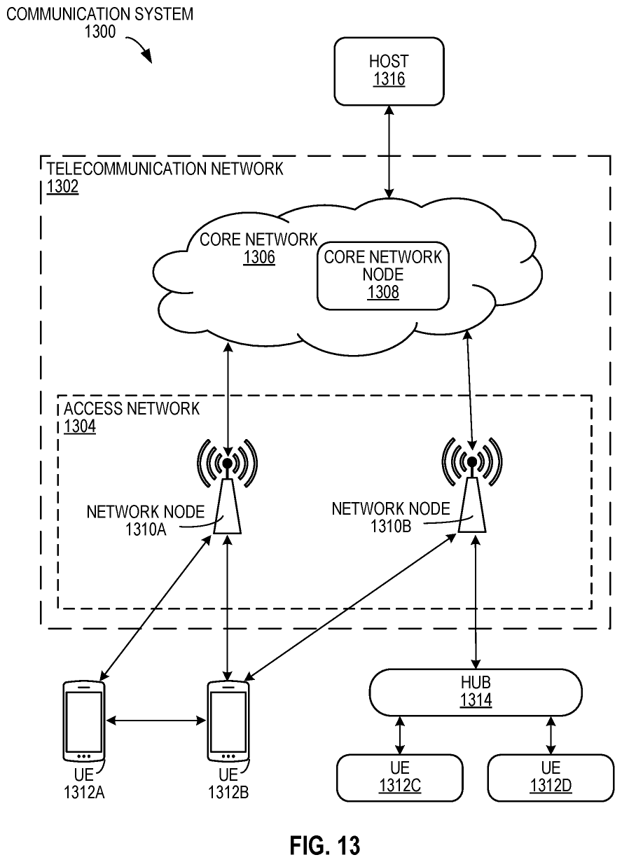

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3^{rd} Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

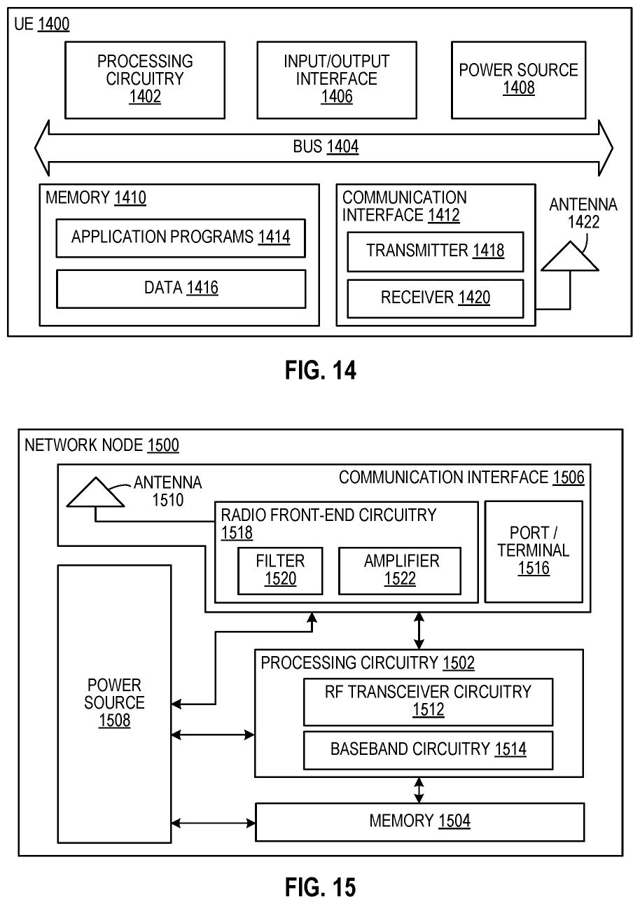

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

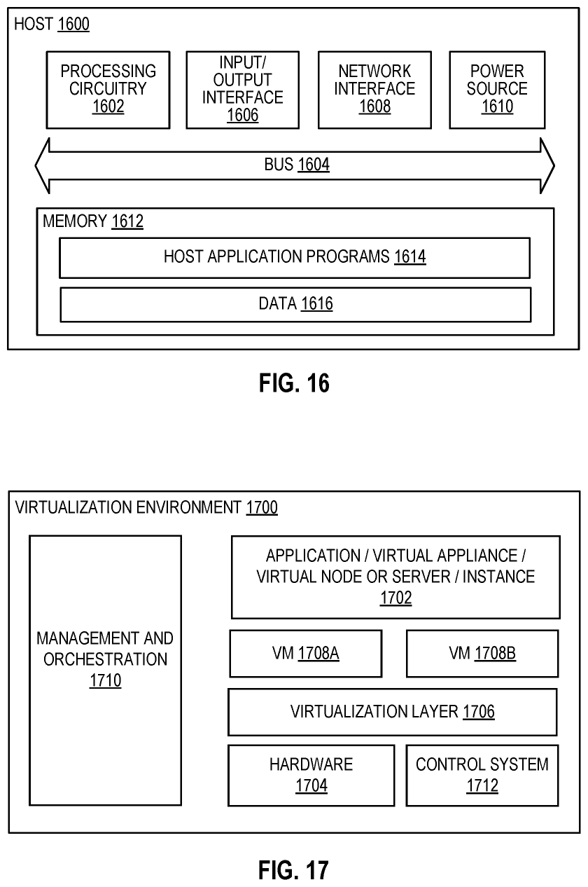

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

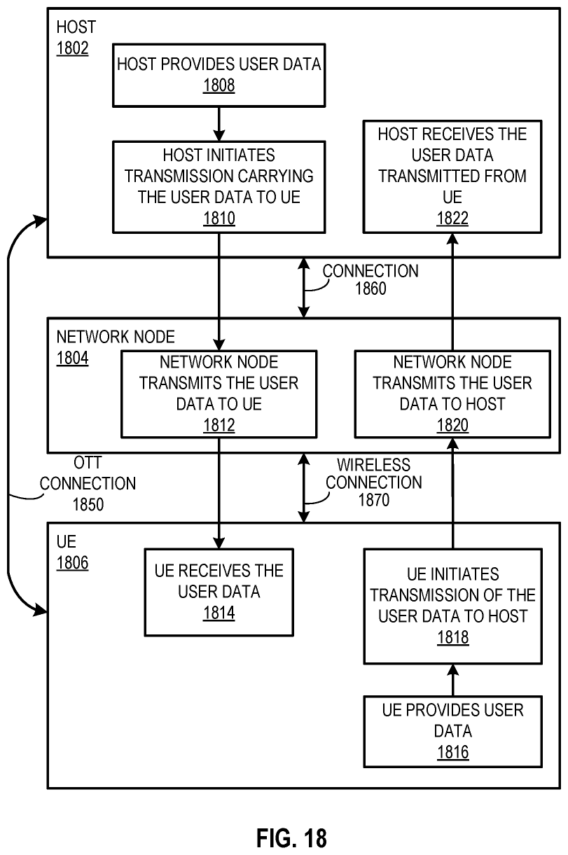

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the U”s client application may receive request data from the hos”s host application and provide user data in response to the request data. The OTT connection 1850 may transfer both the request data and the user data. The U”s client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments (API Invoker—Access Token Embodiments)

A1. A method performed by communication equipment configured to invoke an application programming interface, API, to access a service, the method comprising:
transmitting, from the communication equipment to API exposing equipment configured to expose the API, a request to invoke the API; and
transmitting, from the communication equipment to the API exposing equipment, an access token that indicates whether a resource owner consents to the communication equipment accessing a protected resource of the API.
   A2. The method of embodiment A1, wherein the access token is included in the request.
   A3. The method of embodiment A1, wherein transmitting the request and the access token comprises transmitting, to the API exposing equipment, a message that includes both the request and the access token.
   A4. The method of embodiments A1-A3, wherein transmitting the access token comprises transmitting the access token to the API exposing equipment before, or at the same time as, transmitting the request to the API exposing equipment.
   A5. The method of any of embodiments A1-A4, wherein the access token includes consent information asserting that the resource owner consents, or does not consent, to the communication equipment accessing the protected resource of the API.
   A6. The method of embodiment A5, wherein the consent information is a claim asserting that the resource owner consents, or does not consent, to the communication equipment accessing the protected resource of the API.
   A7. The method of any of embodiments A1-A6, wherein the access token is an oAuth 2.0 access token.
   A8. The method of any of embodiments A1-A7, wherein the API is a Northbound API.
   A9. The method of any of embodiments A1-A8, wherein the communication equipment is a user equipment.
   A10. The method of any of embodiments A1-A9, wherein the resource owner is a user of the communication equipment.
   A11. The method of any of embodiments A1-A10, wherein the communication equipment is network equipment that implements an application function, AF.

A12. The method of any of embodiments A1-A11, wherein the access token also asserts that the communication equipment is authorized to access the API.

A13. The method of any of embodiments A1-A12, further comprising performing the method of any of embodiments AA1-AA10.
AA1. A method performed by communication equipment configured to invoke an application programming interface, API, to access a service, the method comprising:
transmitting, from the communication equipment to common API core equipment, a request for an access token; and
receiving, in response to the request, an access token that indicates whether a resource owner consents to the communication equipment accessing a protected resource of the API.
   AA2. The method of embodiment AA1, wherein the access token includes consent information asserting that the resource owner consents, or does not consent, to the communication equipment accessing the protected resource of the API.
   AA3. The method of embodiment AA2, wherein the consent information is a claim asserting that the resource owner consents, or does not consent, to the communication equipment accessing the protected resource of the API.
   AA4. The method of any of embodiments AA1-AA3, wherein the access token is an oAuth 2.0 access token.
   AA5. The method of any of embodiments AA1-AA4, wherein the API is a Northbound API.
   AA6. The method of any of embodiments AA1-AA3, wherein the communication equipment is a user equipment.
   AA7. The method of any of embodiments AA1-AA6, wherein the resource owner is a user of the communication equipment.
   AA8. The method of any of embodiments AA1-AA7, wherein the communication equipment is network equipment that implements an application function, AF.
   AA9. The method of any of embodiments AA1-AA8, wherein the access token also asserts that the communication equipment is authorized to access the API.
   AA10. The method of any of embodiments AA1-AA9, further comprising, before transmitting the request for the access token:
transmitting an authorization request to the common API core equipment; and
receiving, in response to the authorization request, an authorization code that is a credential representing authorization of the resource owner;
wherein the request for the access token includes the authorization code.
   AA11. The method of any of embodiments AA1-AA10, wherein the common API core equipment implements a CAPIF Core Function.
   AA12. The method of any of embodiments AA1-AA11, further comprising performing the method of any of embodiments A1-A13.

### Group B Embodiments (AEF—Access Token Embodiments)

B1. A method performed by application programming interface, API, exposing equipment configured to expose an API to communication equipment, the method comprising:
receiving, from the communication equipment, a request to invoke the API; and
receiving, from the communication equipment, an access token that indicates whether a resource owner consents to the communication equipment accessing a protected resource of the API.
   B2. The method of embodiment B1, wherein the access token is included in the request.
   B3. The method of embodiment B1, wherein receiving the request and the access token comprises receiving, from the communication equipment, a message that includes both the request and the access token.
   B4. The method of embodiments B1-B3, wherein receiving the access token comprises receiving the access token before, or at the same time as, receiving the request.
   B5. The method of any of embodiments B1-B4, wherein the access token includes consent information asserting that the resource owner consents, or does not consent, to the communication equipment accessing the protected resource of the API.
   B6. The method of embodiment B5, wherein the consent information is a claim asserting that the resource owner consents, or does not consent, to the communication equipment accessing the protected resource of the API.
   B7. The method of any of embodiments B1-B6, wherein the access token is an oAuth 2.0 access token.
   B8. The method of any of embodiments B1-B7, wherein the API is a Northbound API.
   B9. The method of any of embodiments B1-B8, wherein the communication equipment is a user equipment.
   B10. The method of any of embodiments B1-B9, wherein the resource owner is a user of the communication equipment.
   B11. The method of any of embodiments B1-B10, wherein the communication equipment is network equipment that implements an application function, AF.
   B12. The method of any of embodiments B1-B11, wherein the access token also asserts that the communication equipment is authorized to access the API.
   B13. The method of any of embodiments B1-B12, wherein the access token includes one or more claims, including a claim asserting that the resource owner consents to the communication equipment accessing the protected resource of the API, wherein the method further comprises:
verifying the request against the one or more claims in the access token; and
allowing or rejecting the request depending on said verifying.
   B14. The method of any of embodiments B1-B13, further comprising receiving, from common API core equipment, signaling indicating that the resource owner has revoked consent to the communication equipment accessing the protected resource of the API.

### Group C Embodiments (CAPIF Core Function—Access Token Embodiments)

C1. A method performed by common application programming interface, API, core equipment, the method comprising:
receiving, from communication equipment, a request for an access token; and
transmitting, in response to the request, an access token that indicates whether a resource owner consents to the communication equipment accessing a protected resource of an API.
   C2. The method of embodiment C1, wherein the access token includes consent information asserting that the resource owner consents, or does not consent, to the communication equipment accessing the protected resource of the API.
   C3. The method of embodiment C2, wherein the consent information is a claim asserting that the resource owner consents, or does not consent, to the communication equipment accessing the protected resource of the API.
   C4. The method of any of embodiments C1-C3, wherein the access token is an oAuth 2.0 access token.
   C5. The method of any of embodiments C1-C4, wherein the API is a Northbound API.
   C6. The method of any of embodiments C1-C5, wherein the communication equipment is a user equipment.
   C7. The method of any of embodiments C1-C6, wherein the resource owner is a user of the communication equipment.
   C8. The method of any of embodiments C1-C7, wherein the communication equipment is network equipment that implements an application function, AF.
   C9. The method of any of embodiments C1-C8, wherein the access token also asserts that the communication equipment is authorized to access the API.
   C10. The method of any of embodiments C1-C9, further comprising, before receiving the request for the access token:
receiving an authorization request from the communication equipment; and
transmitting, in response to the authorization request, an authorization code to the communication equipment;
wherein the request for the access token includes the authorization code;
wherein the authorization code is a credential representing authorization of the resource owner.
   C11. The method of embodiment C10, further comprising:
responsive to receiving the authorization request, retrieving user consent parameters from unified data management, UDM, equipment, wherein the user consent parameters indicate whether the resource owner has granted consent to the communication equipment accessing the protected resource of the API; and
generating the authorization code based on the user consent parameters.
   C12. The method of any of embodiments C1-C9, further comprising:
responsive to receiving the request for the access token, retrieving user consent parameters from unified data management, UDM, equipment, wherein the user consent parameters indicate whether the resource owner has granted consent to the communication equipment accessing the protected resource of the API; and
generating the access token based on the user consent parameters.
   C13. The method of any of embodiments C1-C12, further comprising subscribing to updates to user consent parameters from unified data management, UDM, equipment.
   C14. The method of any of embodiments C1-C13, further comprising:
receiving, from unified data management, UDM, equipment, notification that the resource owner has revoked consent to the communication equipment accessing the protected resource of the API; and
based on the notification, transmitting, to API exposing equipment configured to expose the API, signaling indicating that the resource owner has revoked consent to the communication equipment accessing the protected resource of the API.

### Group D Embodiments (AEF—Non Access Token Embodiments)

D1. A method performed by application programming interface, API, exposing equipment configured to expose an API to communication equipment, the method comprising:
receiving, from the communication equipment, a request to invoke the API; and
retrieving, from common API core equipment, one or more user consent parameters that indicate whether a resource owner consents to the communication equipment accessing a protected resource of the API.
   D2. The method of embodiment D1, wherein the one or more user consent parameters are retrieved from the common API core equipment in response to transmitting a request for the one or more user consent parameters to the common API core equipment.
   D3. The method of any of embodiments D1-D2, wherein the one or more user consent parameters are retrieved from the common API core equipment along with authorization information indicating whether or not the communication equipment is authorized to access the API.
   D4. The method of embodiments D1-D3, wherein the one or more user consent parameters are retrieved after and/or responsive to receiving the request.
   D5. The method of any of embodiments D1-D4, wherein the API is a Northbound API.
   D6. The method of any of embodiments D1-D5, wherein the communication equipment is a user equipment.
   D7. The method of any of embodiments D1-D6, wherein the resource owner is a user of the communication equipment.
   D8. The method of any of embodiments D1-D7, wherein the communication equipment is network equipment that implements an application function, AF.
   D9. The method of any of embodiments D1-D8, further comprising allowing or rejecting the request depending on whether the resource owner consents to the communication equipment accessing the protected resource of the API.

### Group E Embodiments (CAPIF Core Function—Non Access Token Embodiments)

E1. A method performed by common application programming interface, API, core equipment, the method comprising:
receiving, from API exposing equipment, a request for one or more user consent parameters that indicate whether a resource owner consents to a communication equipment accessing a protected resource of an API; and
transmitting the one or more user consent parameter to the API exposing equipment in response to the request.
   E2. The method of embodiment E1, further comprising retrieving the one or more user consent parameters from user data management, UDM, equipment responsive to receiving the request.
   E3. The method of any of embodiments E1-E2, wherein the API is a Northbound API.
   E4. The method of any of embodiments E1-E3, wherein the communication equipment is a user equipment.
   E5. The method of any of embodiments E1-E4, wherein the resource owner is a user of the communication equipment.
   E6. The method of any of embodiments E1-E5, wherein the communication equipment is network equipment that implements an application function, AF.
   E7. The method of any of embodiments E1-E6, wherein the one or more user consent parameters are transmitted along with authorization information indicating whether or not the communication equipment is authorized to access the API.

### Group F Embodiments

F1. Communication equipment configured to perform any of the steps of any of the Group A embodiments.
F2. Communication equipment comprising processing circuitry configured to perform any of the steps of any of the Group A embodiments.
F3. Communication equipment comprising:
communication circuitry; and
processing circuitry configured to perform any of the steps of any of the Group A embodiments.
   F4. Communication equipment comprising:
processing circuitry configured to perform any of the steps of any of the Group A embodiments; and
power supply circuitry configured to supply power to the communication equipment.
   F5. Communication equipment comprising:
processing circuitry and memory, the memory containing instructions executable by the processing circuitry whereby the communication equipment is configured to perform any of the steps of any of the Group A embodiments.
   F6. Communication equipment of any of embodiments C1-C5, wherein the communication equipment is a wireless communication device.
   F7. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and a battery connected to the processing circuitry and configured to supply power to the UE.
   F8. A computer program comprising instructions which, when executed by at least one processor of communication equipment, causes the communication equipment to carry out the steps of any of the Group A embodiments.
   F9. A carrier containing the computer program of embodiment C7, wherein the carrier is one of an electronic signal, optical signal, radio signal, or computer readable storage medium.
   F10. Application programming interface, API, exposing equipment configured to perform any of the steps of any of the Group B or Group D embodiments.
   F11. Application programming interface, API, exposing equipment comprising processing circuitry configured to perform any of the steps of any of the Group B or Group D embodiments.
   F12. Application programming interface, API, exposing equipment comprising:
communication circuitry; and
processing circuitry configured to perform any of the steps of any of the Group B or Group D embodiments.
   F13. Application programming interface, API, exposing equipment comprising:
processing circuitry configured to perform any of the steps of any of the Group B or Group D embodiments;
power supply circuitry configured to supply power to the API exposing equipment.
   F14. Application programming interface, API, exposing equipment comprising:
processing circuitry and memory, the memory containing instructions executable by the processing circuitry whereby the API exposing equipment is configured to perform any of the steps of any of the Group B or Group D embodiments.
   F15. The API exposing equipment of any of embodiments F10-F14, wherein the API exposing equipment is a base station.
   F16. A computer program comprising instructions which, when executed by at least one processor of application programming interface, API, exposing equipment, causes the API exposing equipment to carry out the steps of any of the Group B or Group D embodiments.
   F17. The computer program of embodiment F16, wherein the API exposing equipment is a base station.
   F18. A carrier containing the computer program of any of embodiments F16-F17, wherein the carrier is one of an electronic signal, optical signal, radio signal, or computer readable storage medium.
   F19. Common application programming interface, API, core equipment configured to perform any of the steps of any of the Group C or Group E embodiments.
   F20. Common application programming interface, API, core equipment comprising processing circuitry configured to perform any of the steps of any of the Group C or Group E embodiments.
   F21. Common application programming interface, API, core equipment comprising: communication circuitry; and processing circuitry configured to perform any of the steps of any of the Group C or Group E embodiments.
   F22. Common application programming interface, API, core equipment comprising:
processing circuitry configured to perform any of the steps of any of the Group C or Group E embodiments;
power supply circuitry configured to supply power to the common API core equipment.
   F23. Common application programming interface, API, core equipment comprising:
processing circuitry and memory, the memory containing instructions executable by the processing circuitry whereby the common API core equipment is configured to perform any of the steps of any of the Group C or Group E embodiments.
   F24. The common API core equipment of any of embodiments F19-F23, wherein the common API core equipment is a base station.
   F25. A computer program comprising instructions which, when executed by at least one processor of common application programming interface, API, core equipment, causes the common API core equipment to carry out the steps of any of the Group C or Group E embodiments.
   F26. The computer program of embodiment F25, wherein the common API core equipment is a base station.
   F27. A carrier containing the computer program of any of embodiments F25-F26, wherein the carrier is one of an electronic signal, optical signal, radio signal, or computer readable storage medium.

### Group G Embodiments

G1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B-E embodiments.
   G2. The communication system of the previous embodiment further including the base station.
   G3. The communication system of the previous 2 embodiments, further including the UE, wherein the UE is configured to communicate with the base station.
   G4. The communication system of the previous 3 embodiments, wherein:
the processing circuitry of the host computer is configured to execute a host application, thereby providing the user data; and
the UE comprises processing circuitry configured to execute a client application associated with the host application.
   G5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B-E embodiments.
   G6. The method of the previous embodiment, further comprising, at the base station, transmitting the user data.
   G7. The method of the previous 2 embodiments, wherein the user data is provided at the host computer by executing a host application, the method further comprising, at the UE, executing a client application associated with the host application.
   G8. A user equipment (UE) configured to communicate with a base station, the UE comprising a radio interface and processing circuitry configured to perform any of the previous 3 embodiments.
   G9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.
   G10. The communication system of the previous embodiment, wherein the cellular network further includes a base station configured to communicate with the UE.
   G11. The communication system of the previous 2 embodiments, wherein:
the processing circuitry of the host computer is configured to execute a host application, thereby providing the user data; and
the UE's processing circuitry is configured to execute a client application associated with the host application.
   G12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.
   G13. The method of the previous embodiment, further comprising at the UE, receiving the user data from the base station.
   G14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.
   G15. The communication system of the previous embodiment, further including the UE.
   G16. The communication system of the previous 2 embodiments, further including the base station, wherein the base station comprises a radio interface configured to communicate with the UE and a communication interface configured to forward to the host computer the user data carried by a transmission from the UE to the base station.
   G17. The communication system of the previous 3 embodiments, wherein:
the processing circuitry of the host computer is configured to execute a host application; and
the UE's processing circuitry is configured to execute a client application associated with the host application, thereby providing the user data.
   G18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   G19. A method implemented in a communication system including a host computer, a base station and a user equipment (UE), the method comprising:
at the host computer, receiving user data transmitted to the base station from the UE, wherein the UE performs any of the steps of any of the Group A embodiments.
   G20. The method of the previous embodiment, further comprising, at the UE, providing the user data to the base station.
   G21. The method of the previous 2 embodiments, further comprising:
at the UE, executing a client application, thereby providing the user data to be transmitted; and
at the host computer, executing a host application associated with the client application.
   G22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   G23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B-E embodiments.
   G24. The communication system of the previous embodiment further including the base station.
   G25. The communication system of the previous 2 embodiments, further including the UE, wherein the UE is configured to communicate with the base station.
   G26. The communication system of the previous 3 embodiments, wherein:
the processing circuitry of the host computer is configured to execute a host application;
the UE is configured to execute a client application associated with the host application, thereby providing the user data to be received by the host computer.
   G27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.
   G28. The method of the previous embodiment, further comprising at the base station, receiving the user data from the UE.
   G29. The method of the previous 2 embodiments, further comprising at the base station, initiating a transmission of the received user data to the host computer.

1.-45. (canceled)

46. A method performed by communication equipment configured to invoke an application programming interface (API) to access a service, the method comprising:
transmitting, from the communication equipment to API exposing equipment configured to expose the API, a request to invoke the API; and
transmitting, from the communication equipment to the API exposing equipment, an access token that indicates whether a resource owner consents to the communication equipment accessing a protected resource of the API.

47. The method of claim 46, wherein the access token is included in the request, or wherein transmitting the request and the access token comprises transmitting, to the API exposing equipment, a message that includes both the request and the access token.

48. The method of claim 46, wherein the access token:
includes a claim asserting that the resource owner consents, or does not consent, to the communication equipment accessing the protected resource of the API; and/or
also asserts that the communication equipment is authorized to access the API.

49. The method of claim 46, further comprising:
transmitting, from the communication equipment to common API core equipment, a request for an access token; and
receiving the access token in response to the request.

50. The method of claim 49, further comprising, before transmitting the request for the access token:
transmitting an authorization request to the common API core equipment; and
receiving, in response to the authorization request, an authorization code that is a credential representing authorization of the resource owner;
wherein the request for the access token includes the authorization code.

51. A method performed by application programming interface (API) exposing equipment configured to expose an API to communication equipment, the method comprising:
receiving, from the communication equipment, a request to invoke the API; and
receiving, from the communication equipment, an access token that indicates whether a resource owner consents to the communication equipment accessing a protected resource of the API.

52. The method of claim 51, wherein the access token is included in the request, or wherein receiving the request and the access token comprises receiving, from the communication equipment, a message that includes both the request and the access token.

53. The method of claim 51, wherein the access token:
includes a claim asserting that the resource owner consents, or does not consent, to the communication equipment accessing the protected resource of the API; and/or
also asserts that the communication equipment is authorized to access the API.

54. The method of claim 51, wherein the access token includes one or more claims, including a claim asserting that the resource owner consents to the communication equipment accessing the protected resource of the API, wherein the method further comprises:
verifying the request against the one or more claims in the access token; and
allowing or rejecting the request depending on said verifying.

55. A method performed by common application programming interface (API) core equipment, the method comprising:
receiving, from communication equipment, a request for an access token; and
transmitting, in response to the request, an access token that indicates whether a resource owner consents to the communication equipment accessing a protected resource of an API.

56. The method of claim 55, wherein the access token:
includes a claim asserting that the resource owner consents, or does not consent, to the communication equipment accessing the protected resource of the API; and/or
also asserts that the communication equipment is authorized to access the API.

57. The method of claim 55, further comprising, before receiving the request for the access token:
receiving an authorization request from the communication equipment;
responsive to receiving the authorization request, retrieving user consent parameters from unified data management (UDM) equipment, wherein the user consent parameters indicate whether the resource owner has granted consent to the communication equipment accessing the protected resource of the API; and
generating an authorization code based on the user consent parameters;
transmitting, in response to the authorization request, the authorization code to the communication equipment;
wherein the request for the access token includes the authorization code;
wherein the authorization code is a credential representing authorization of the resource owner.

58. The method of claim 55, further comprising:
responsive to receiving the request for the access token, retrieving user consent parameters from unified data management (UDM) equipment, wherein the user consent parameters indicate whether the resource owner has granted consent to the communication equipment accessing the protected resource of the API; and
generating the access token based on the user consent parameters.

59. Communication equipment configured to invoke an application programming interface (API) to access a service, the communication equipment comprising:
communication circuitry; and
processing circuitry configured to:
transmit, from the communication equipment to API exposing equipment configured to expose the API, a request to invoke the API; and
transmit, from the communication equipment to the API exposing equipment, an access token that indicates whether a resource owner consents to the communication equipment accessing a protected resource of the API.

60. The communication equipment of claim 59, wherein the processing circuitry is configured to include the access token in the request, or to transmit, to the API exposing equipment, a message that includes both the request and the access token.

61. The communication equipment of claim 59, wherein the access token:
includes a claim asserting that the resource owner consents, or does not consent, to the communication equipment accessing the protected resource of the API; and/or
also asserts that the communication equipment is authorized to access the API.

62. The communication equipment of claim 59, wherein the processing circuitry is further configured to:
transmit, from the communication equipment to common API core equipment, a request for an access token; and
receive the access token in response to the request.

63. The communication equipment of claim 59, wherein the processing circuitry is further configured to, before transmitting the request for the access token:
transmit an authorization request to the common API core equipment; and
receive, in response to the authorization request, an authorization code that is a credential representing authorization of the resource owner;
wherein the request for the access token includes the authorization code.

64. Application programming interface (API) exposing equipment configured to expose an API to communication equipment, the API exposing equipment comprising:
communication circuitry; and
processing circuitry configured to:
receive, from the communication equipment, a request to invoke the API; and
receive, from the communication equipment, an access token that indicates whether a resource owner consents to the communication equipment accessing a protected resource of the API.

65. The API exposing equipment of claim 64, wherein the access token is included in the request, or wherein the processing circuitry is configured to receive the request and the access token by receiving, from the communication equipment, a message that includes both the request and the access token.

66. The API exposing equipment of claim 64, wherein the access token:
includes a claim asserting that the resource owner consents, or does not consent, to the communication equipment accessing the protected resource of the API; and/or
also asserts that the communication equipment is authorized to access the API.

67. The API exposing equipment of claim 64, wherein the access token includes one or more claims, including a claim asserting that the resource owner consents to the communication equipment accessing the protected resource of the API, wherein the processing circuitry is further configured to:
verify the request against the one or more claims in the access token; and
allow or reject the request depending on said verifying.

68. Common application programming interface (API) core equipment, the common API core equipment comprising:
communication circuitry; and
processing circuitry configured to:
receive, from communication equipment, a request for an access token; and
transmit, in response to the request, an access token that indicates whether a resource owner consents to the communication equipment accessing a protected resource of an API.

69. The common API core equipment of claim 68, wherein the access token:
includes a claim asserting that the resource owner consents, or does not consent, to the communication equipment accessing the protected resource of the API; and/or
also asserts that the communication equipment is authorized to access the API.

70. The common API core equipment of claim 68, wherein the processing circuitry is further configured to, before receiving the request for the access token:
receive an authorization request from the communication equipment;
responsive to receiving the authorization request, retrieve user consent parameters from unified data management (UDM) equipment, wherein the user consent parameters indicate whether the resource owner has granted consent to the communication equipment accessing the protected resource of the API; and
generate an authorization code based on the user consent parameters; and
transmit, in response to the authorization request, the authorization code to the communication equipment;
wherein the request for the access token includes the authorization code;
wherein the authorization code is a credential representing authorization of the resource owner.

71. The common API core equipment of claim 68, wherein the processing circuitry is further configured to:
responsive to receiving the request for the access token, retrieve user consent parameters from unified data management (UDM) equipment, wherein the user consent parameters indicate whether the resource owner has granted consent to the communication equipment accessing the protected resource of the API; and
generate the access token based on the user consent parameters.
